(19) United States
(12) Patent Application Publication
(10) Pub. No.: US 2025/0132941 A1
(43) Pub. Date: Apr. 24, 2025

(54) ACTION BASED SUMMARIZATION INCLUDING NON-VERBAL EVENTS BY MERGING REAL-TIME MEDIA MODEL WITH LARGE LANGUAGE MODEL

(71) Applicant: Cisco Technology, Inc., San Jose, CA (US)

(72) Inventors: Keith Griffin, Oranmore (IE); Anurag Dhingra, Fremont, CA (US); Lorrissa J. Horton, Seattle, WA (US); Amit P. Barave, Cupertino, CA (US)

(21) Appl. No.: 18/809,853

(22) Filed: Aug. 20, 2024

Related U.S. Application Data
(60) Provisional application No. 63/592,744, filed on Oct. 24, 2023.

(51) Int. Cl. H04L 12/18; G06F 3/01

(52) U.S. Cl. CPC H04L 12/1831; G06F 3/017

(57) ABSTRACT

In one embodiment, a method includes obtaining content captured during a collaboration session, processing the content to identify a first cue included in the content, and interpreting the first cue, wherein interpreting the first cue includes generating a first insight associated with the first cue. The method also includes processing the first insight to generate an insight summary, and generating an output associated with the collaboration session, wherein the output includes the insight summary.

### PRIORITY CLAIM

This patent application claims the benefit of priority under 35 U.S.C. § 119 to U.S. Provisional Patent Application No. 63/592,744, filed Oct. 24, 2023, and entitled “ACTION BASED SUMMARIZATION INCLUDING NON-VERBAL EVENTS BY MERGING REAL-TIME MEDIA MODEL WITH LARGE LANGUAGE MODEL,” which is incorporated herein by reference in its entirety.

### TECHNICAL FIELD

The present disclosure relates for processing multi-media content using generative models for summarizing the media content, such as from a multi-participant collaboration (online/video conference) session, in a transcript.

### BACKGROUND

Large Language Models (LLMs) have had a significant impact on text-based workloads solving for areas such as summarization. However, such summarization is typically based on text. In communication sessions that involve audio, video, content sharing, etc., there is an opportunity to expand the capabilities of generative artificial intelligence applied to multiple media forms.

### BRIEF DESCRIPTION OF THE DRAWINGS

The disclosure will be readily understood by the following detailed description in conjunction with the accompanying drawings in which:

FIG. 1A is a diagrammatic representation of an intelligence system which includes a large language model (LLM) and a Real-Time Media Model (RMM) in accordance with an embodiment.

FIG. 1B is a diagrammatic representation of an intelligence system, e.g., intelligence system 148 of FIG. 1A, that includes a collaboration application in accordance with an embodiment.

FIG. 1C is a diagrammatic representation of an intelligence system, e.g., intelligence system 148 of FIG. 1B, that obtains information from participants in a collaboration session, e.g., collaboration session 160 of FIG. 1B, in accordance with an embodiment.

FIG. 2 is a diagrammatic representation of a general system that is arranged to generate a transcript from a meeting in accordance with an embodiment.

FIG. 3 is a diagrammatic representation of an example of a system that is arranged to generate a transcript associated with a session in accordance with an embodiment.

FIG. 4 is a process flow diagram which illustrates a method of operating an intelligence system that includes a transcript generation arrangement in accordance with an embodiment.

FIG. 5 is a diagrammatic representation of an intelligence system which processes content that includes a facial expression of a participant in a collaboration session in accordance with an embodiment.

FIG. 6 is a diagrammatic representation of an intelligence system, e.g., intelligence system 548 of FIG. 5, which processes content that includes a lack of a response from a participant in a collaboration session, e.g., participant 562 and collaboration session 560 of FIG. 5, in accordance with an embodiment.

FIG. 7 is a diagrammatic representation of an intelligence system, e.g., intelligence system 548 of FIG. 5, which processes content that includes an action within a scene captured during a collaboration session, e.g., collaboration session 560 of FIG. 5, in accordance with an embodiment.

FIG. 8 is a diagrammatic representation of a general transcript that includes insight summaries in accordance with an embodiment.

FIG. 9 is a diagrammatic representation of an example of a transcript that includes insight summaries in accordance with an embodiment.

FIG. 10 is a hardware block diagram of a networking/computing device/apparatus/appliance/endpoint that may perform functions associated with any combination of operations in connection with the techniques described with respect to FIGS. 1A-C and 2-9.

### DETAILED DESCRIPTION

### Overview

Techniques are presented herein that combine outputs generated using Real-Time Media Models (RMMs) and large language models (LLMs), and act on the combined outputs. Techniques include, but are not limited to including, techniques that enhance the intelligence provided for a meeting transcript using knowledge derived by an LLM from cues, e.g., non-verbal cues, detected by one or more RMMs.

According to one aspect, a method includes obtaining content captured during a collaboration session, processing the content to identify a first cue included in the content, and interpreting the first cue, wherein interpreting the first cue includes generating a first insight associated with the first cue. The method also includes processing the first insight to generate an insight summary, and generating an output associated with the collaboration session, wherein the output includes the insight summary.

### EXAMPLE EMBODIMENTS

Large Language Models (LLMs) are generative artificial intelligence (AI) models that recognize and generate text. As will be appreciated by those skilled in the art, an LLM may derive language intelligence from text context and verbal content. However, an LLM is not arranged to derive language intelligence from other content such as non-verbal or non-textual content including, but not limited to including, audio content, video content, images, and/or documents.

Real-Time Media Models (RMMs) are AI models that operate on media that is non-textual. RMMs may operate on media including, but not limited to including. audio, video and other content shared, for example, during a collaboration session such as a video conference session. RMMs effectively extract data from audio and visual cues, including, but not limited to including, a tone of voice, an intonation of a voice, a physical action such as a gesture, and a facial expression. The extracted data may then essentially be transformed into insights, e.g., real-time insights, that may be processed by an LLM.

Combining AI features from LLMs and RMMs by substantially fusing or merging AI for text, audio, and video provides enhanced capabilities with respect to the use of AI. By way of example, an RMM may interpret video and/or audio data, and provide insights associated with the interpretation to an LLM for use in enhancing capabilities of the LLM. That is, using insights provided by an RMM, an LLM may effectively transform or otherwise turn the insights into actions. Further, insights provided to an LLM by an RMM may be used by the LLM to provide new or enhanced features for use with collaboration applications, e.g., to provide new or enhanced features associated with existing features such as Bring Me Back (BMB) and Be Right Back (BRB) functionality.

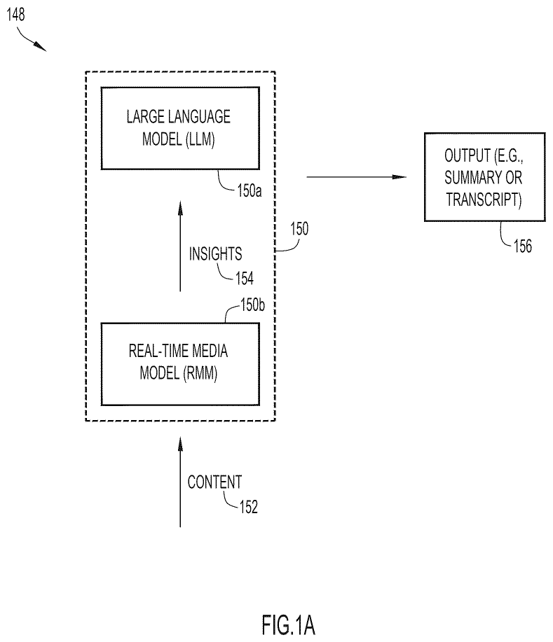

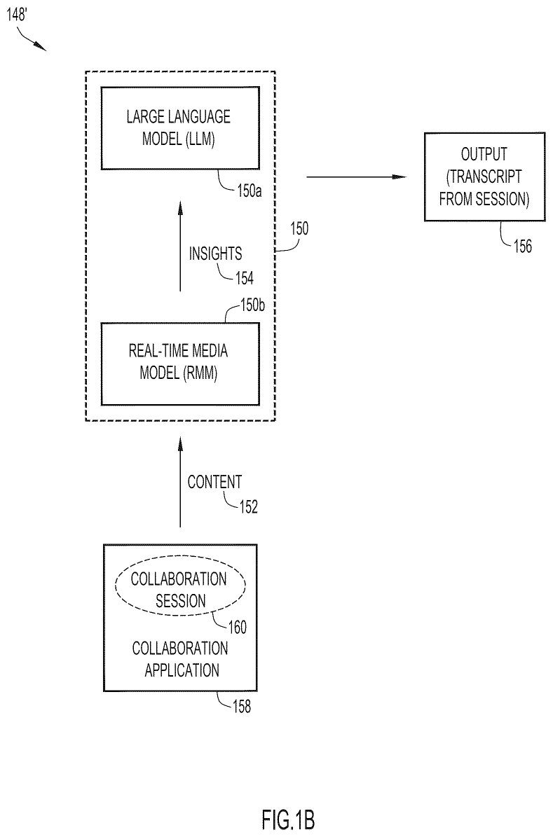

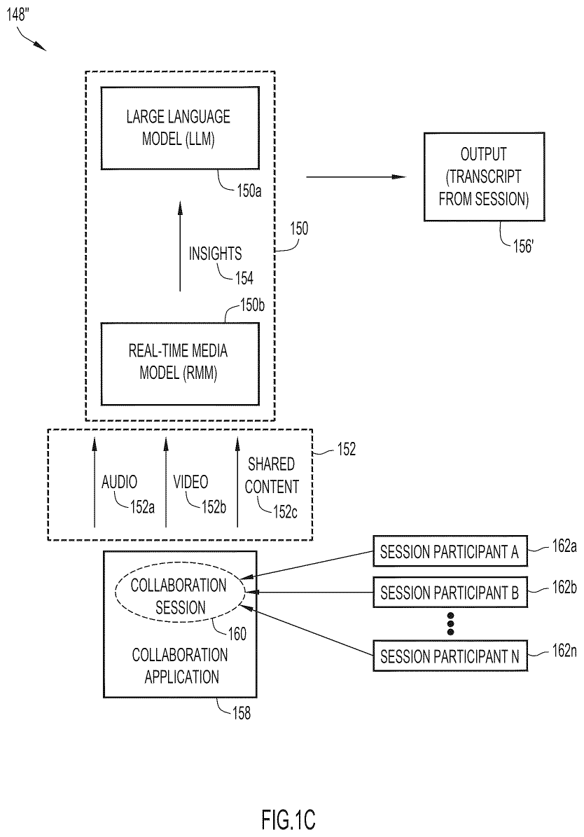

An LLM and an RMM may be combined or effectively merged to form an overall AI system that is part of an intelligence system that is configured to transform substantially any content into output that includes actions that correspond to the content. The content may include verbal and non-verbal content. FIG. 1A is a diagrammatic representation of an intelligence system which includes an LLM and an RMM in accordance with an embodiment. An intelligence system 148, which may be a framework or a platform, includes an AI system 150 which is arranged to obtain content 152 as an input, and generate an output 156 which effectively that includes an action associated with content 152, e.g., media content that includes non-verbal content. AI system 150 may be hosted on any suitable system including, but not limited to including, a computing system, a server system, and/or a distributed server system.

AI system 150 includes an LLM 150a and a RMM 150b. It should be appreciated that although one LLM 150a and one RMM 150b are shown, AI system 150 may also include more than one LLM 150a and more than one RMM 150b. LLM 150a and RMM 150b may be hosted on different servers in a distributed server system such that LLM 150a and RMM 150b are in communication over a network. That is, AI system 150 may be a distributed system. For example, LLM 150a may be a cloud service and RMM 150b may be an edge or client service such that signals between LLM 150a and RMM 150b may be exchanged. A gateway component (not shown) may optionally be included to substantially manage signals between LLM 150a and RMM 150b. In one embodiment, LLM 150a includes language intelligence, while RMM 150b includes audio intelligence and video intelligence. RMM 150b is configured to obtain content 152 from any suitable source. As will be discussed below with respect to FIG. 1B, a suitable source may be a collaboration application. Content 152 may include, but is not limited to including, audio content, video content, and content related to cues, e.g., gestures made by or actions taken by a human. RMM 150b processes content 152 to substantially generate one or more insights 154, e.g., to effectively identify and interpret one or more events detected in content 152. Insights 154 are generally provided by RMM 150b to LLM 150a in a format that LLM 150a may process. By way of example, insights 154 may be provided to LLM 150a as text-based or language-based input. The text-based or language-based input may be based on prompts that may contain a query and/or an optional instruction, e.g., a query to interpret insight 154 with an instruction to provide a response in a particular manner. LLM 150a may process or otherwise transform insights 154 into one or more actions that may be included in output 156. For example, when output 156 is a summary or a transcript, the one or more actions generated from insights 154 may be included the summary or the transcript. A transcript or transcription record, as will be appreciated by those skilled in the art, is a record, e.g., a written record, of substantially all spoken audio captured during a collaboration session such as a meeting.

One suitable source from which content 152 may be obtained is a collaboration application, e.g., a video conference application. Referring next to FIG. 1B, system, the inclusion of a collaboration application in intelligence system 148 will be described in accordance with an embodiment. Intelligence system 148′ includes a collaboration application 158 which supports a collaboration session 160. Collaboration application 158 may be a platform which enables collaboration through unified communications, conferences, meetings, calls, chats, and/or sharing resources such as documents. Collaboration session 160 may be, but is not limited to being, a web conference, a video meeting, a video conference, an audio meeting, an audio conference, and/or a group chat.

Content 152 relating to collaboration session 160 may be provided by collaboration application 158 to AI system 150, e.g., to RMM 150b. Insights 154. may then be generated by RMM 150b using content 152, and processed by LLM 150a to generate output 156.

Collaboration session 160 may generally include one or more session participants. FIG. 1C is a representation of intelligence system 148′ which includes collaboration session 160 and multiple session participants in accordance with an embodiment. Intelligence system 148″ includes session participants 162a-n who may each participate in collaboration session 160. Although session participant 162a, session participant 162b, and session participant 162n are shown, it should be appreciated that the number of session participants 162a-n may vary widely.

Session participants 162a-n may each participate in collaboration session 160, which may include a meeting space, using any suitable device that may enable access to collaboration application 158. Devices used by session participants 162a-n may effectively host collaboration application 158 and/or otherwise allow access to collaboration application 158. By way of example, suitable devices may include, but are not limited including, computers, laptops, mobile devices such as cell phones, and/or tablets.

While session participants 162a-n participate in collaboration session 160, content 152 may be generated. In one embodiment, content 152 may include, but is not limited to including, audio content 152a, video content 152b, and shared content 152c such as shared documents or shared media.

Audio content 152a, video content 152b, and shared content 152c may be provided as input to RMM 150b or, more generally, AI system 150. RMM 150b may process audio content 152a, video content 152b, and shared content 152c to detect or to otherwise identify events including, but not limited to including, reactions from session participants 162a-n, gestures made by session participants 162a-n, voice tones of participants 162a-n, voice inflections of session participants 162a-n, and/or background audio or video associated with collaboration session 160. Upon processing content 152. RMM 150b may create insights 154 or events which may be provided as input to LLM 150a. LLM 150a may then interpret insights 154 or events to effectively generate output 156. It should be appreciated that LLM 150a may interpret insights 154 or events, together with text-based and/or language-based input that may also be provided as input to LLM 150a.

Output 156′ may be a transcript from collaboration session 160, and may include at least one action associated with content 152a-c. The action associated with content 152a-c may be associated with an interpretation of insights 154, e.g., may be an interpretation of events detected by RMM 150b in content 152. While output 156 may be a transcript or summary from collaboration session 160, it should be understood that output 156 is not limited to being a transcript or a summary. Output 156 may also include, but is not limited to including, email, messages, and/or other documents which may be enhanced to effectively include one or more interpretations of insights 154.

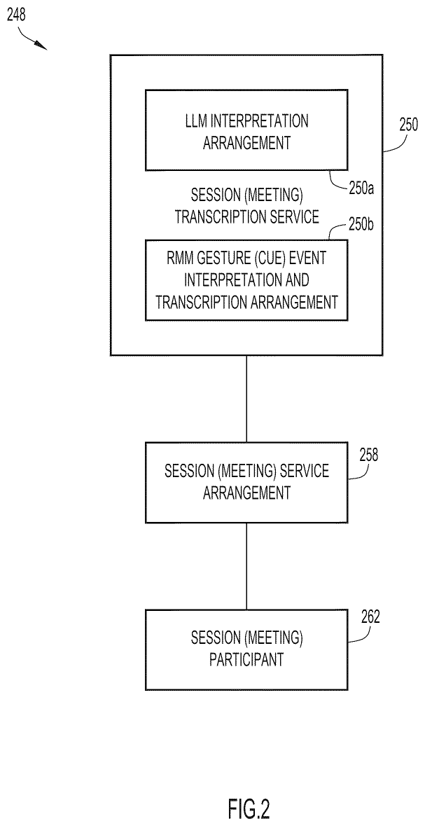

With reference to FIG. 2, a general intelligence system that is arranged to generate a summary or a transcript from a session in accordance with an embodiment. A general intelligence system 248 includes a session transcription service 250 that includes an LLM interpretation arrangement 250a and an RMM gesture event interpretation and transcription arrangement 250b. General intelligence system 248 also includes a session service arrangement 258 and at least one session participant 262. Session transcription service 250, session service arrangement 258, and session participant 262 may communicate using network communications.

Session participant 262 may be an individual with a device such as a computer or a mobile device. Session participant 262 may be in communication with session service arrangement 258, which may generally support a collaboration session or meeting. In other words, session participant 262 participates in a session or a meeting hosted by session service arrangement 258. Gestures made by session participant 262, or actions taken by session participant 262, may be events obtained, e.g., captured or recorded, by session service arrangement 258. Gestures and actions may be considered to be cues, signals, prompts, suggestions, and/or indications obtained by session service arrangement 258 from session participant 262 or from an environment around session participant 262.

RMM gesture, or cue, event interpretation and transcription arrangement 250b is configured to obtain content from session service arrangement 258. The content generally includes audio and/or video content, as well as other content, captured by session service arrangement 258 from session participant 262.

RMM gesture event interpretation and transcription arrangement 250b is configured to process content obtained from session service arrangement 258, and to effectively extract insights or events from the content. The extracted insights or events may be transformed into a format that may be interpreted by LLM interpretation arrangement 250a, and provided to LLM interpretation arrangement 250a. LLM interpretation arrangement 250a may then interpret the insights or events, and generate or otherwise produce a transcript or summary as output. The output includes an indication of the interpreted insights or events.

LLM interpretation arrangement 250a may determine an implication of insights or events identified by RMM gesture event interpretation and transcription arrangement 250b, and summarize outcome of the insights or events in a transcript or summary. By way of example, when an insight or event is that a participant in a meeting has been asked a question but is not available to answer, LLM interpretation arrangement 250a may note this in a transcript or summary.

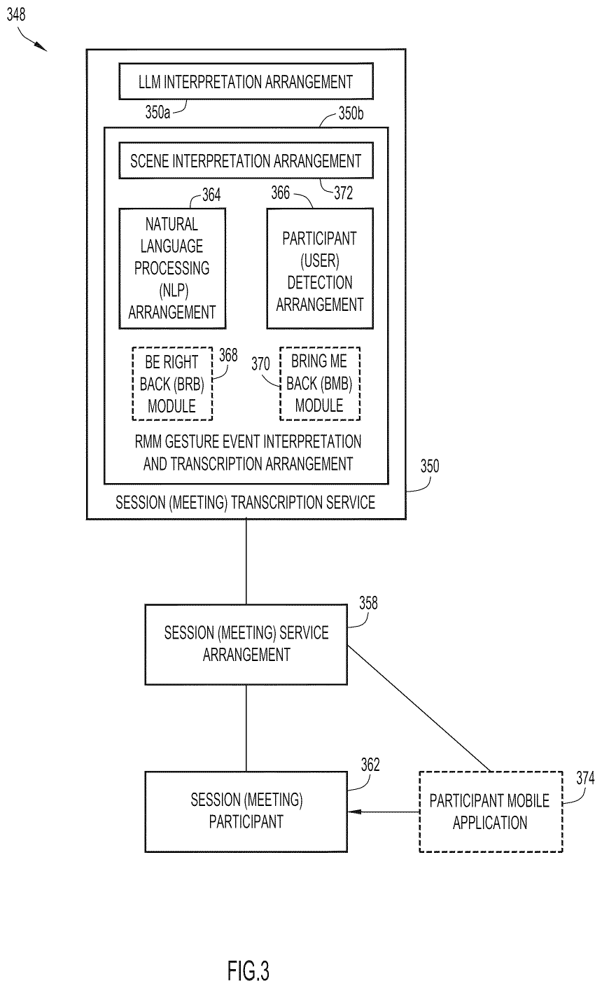

Referring next to FIG. 3, an example of an intelligence system that is arranged to generate a transcript associated with a session will be described in accordance with an embodiment. An intelligence system 348 includes a session transcription service 350, a session service arrangement 358, and a session participant 362. Session transcription service 350 includes an LLM interpretation arrangement 350a and a RMM gesture event interpretation and transcription arrangement 350b.

RMM gesture event interpretation and transcription arrangement 350b includes a natural language processing (NLP) arrangement 364, a participant detection arrangement 366, an optional Be Right Back (BRB) module, an optional Bring Me Back (BMB) module 370, and a scene interpretation arrangement 372. NLP arrangement 364 is configured to process perform NLP on content, e.g., human language content, obtained from session service arrangement 358. Participant detection arrangement 366 is arranged to detect the presence of a session participant 362 in a session hosted by session service arrangement 358.

Optional BRB module 368 is arranged to enable a BRB features which offers a privacy-centric method to allow session participant 362 to step away, as for example temporarily, from a session hosted by session service arrangement 358. Optional BRB module 368 may detect when session participant 362 is no longer present in the session, e.g., in a meeting room. In one embodiment, optional BRB module 368 may determine when session participant 362 provides an indication that he or she is temporarily stepping away and plans to “be right back.” Optional BRB module 368 enables the temporary departure of session participant 362 to be flagged. The departure may be flagged when input from session participant 362 is solicited during the session and session participant 362 is effectively not present in the session, and/or when session participant 362 provides a non-verbal indication that he or she is stepping out of the session.

Optional BMB module 370 may notify session participant 362 that his or her input is requested during a session, and send a notification to an optional participant mobile application 374 via session service arrangement 358 that enables session participant to join the session. For example, session participant 362 may be in possession of a phone device on which optional participant mobile application 374 is hosted, and session participant 362 may join a session through optional participant mobile application 374.

Scene interpretation arrangement 372 is arranged to interpret a scene associated with a session hosted by session service arrangement 358. For example, scene interpretation arrangement 372 may determine when an individual is present in a meeting room, or when multiple session participants including session participant 362 may be exhibiting a common sentiment by making similar gestures, making similar facial expressions, etc.

RMM gesture event interpretation and transcription arrangement 350b may extract insights and events associated with a session hosted by session service arrangement 358, and transform the extracted insights or events may be transformed into a format that may be interpreted by LLM interpretation arrangement 350a. Insights and events may include a record of non-verbal events including BRB events and BMB events. LLM interpretation arrangement 350a may obtain and interpret the insights or events, and generate or otherwise produce a transcript or summary as output. The output includes an indication of the interpreted insights or events.

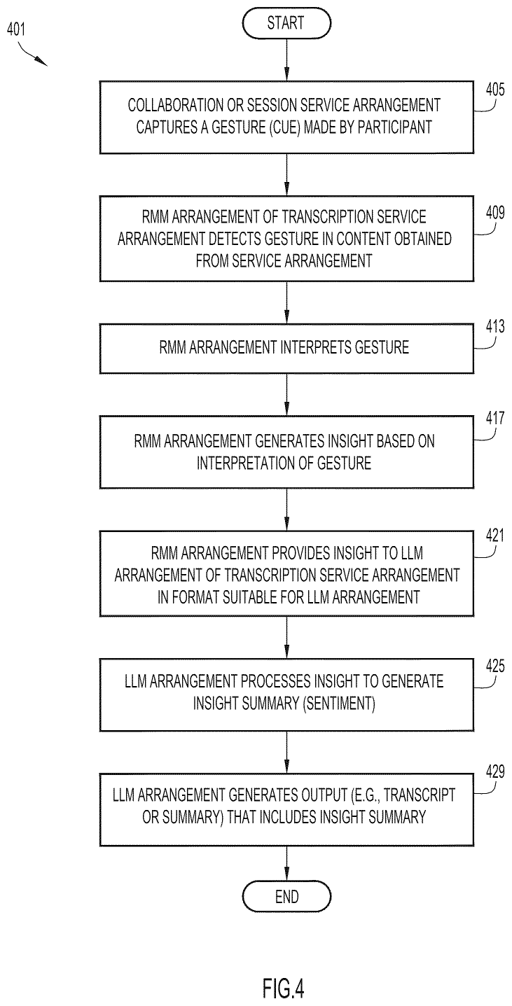

FIG. 4 is a process flow diagram which illustrates a method of operating an intelligence system that includes a transcript generation arrangement in accordance with an embodiment. A method 401 of operating an intelligence system begins at a step 405 in which a collaboration or session service arrangement captures a gesture made by, or a cue indicated by, a participant in a session facilitated by the session service arrangement. That is, the gesture may be captured during a collaboration session hosted by the session service arrangement. In one embodiment, the gesture is a direct gesture that may be intentional and intended to convey a sentiment.

Once the gesture is captured, an RMM arrangement of a transcription service arrangement detects the gesture in a step 409 in content obtained from the session service arrangement. The content obtained from the session service arrangement may include, but is not limited to including, audio content, video content, and shared content.

In a step 413, the RMM arrangement interprets the gesture. That is, the RMM arrangement may process the gesture to determine what the gesture indicates or what message the gesture conveys. By way of example, if the gesture is a thumbs up, it may be determined that the gesture is an indication of an agreement. Upon interpreting the gesture, the RMM arrangement generates an insight or an event based on the interpretation of the gesture in a step 417. For example, an insight based on a thumbs up gesture that indicates an agreement may be an agreement with a particular statement. That is, an insight may be a sentiment or context conveyed by a gesture or, more generally, a cue such as a non-verbal cue.

The RMM arrangement provides the insight or event to an LLM arrangement of the transcription service arrangement in a format suitable for the LLM arrangement in a step 421. Then, in a step 425, the LLM arrangement processes the insight or event to generate an insight summary or a sentiment. The insight summary may include an action associated with the insight. By way of example, when the insight summary indicates an agreement with a particular statement, the action may involve the participant noting that the participant has agreed to perform a particular task specified by a statement.

Once the LLM arrangement processes the insight to generate an insight summary, process flow moves to a step 429 in which the LLM arrangement generates an output that includes the insight summary. The output may be a transcript or a summary of a session hosted by the session service arrangement. Upon the output being generated, the method of operating an intelligence system is completed.

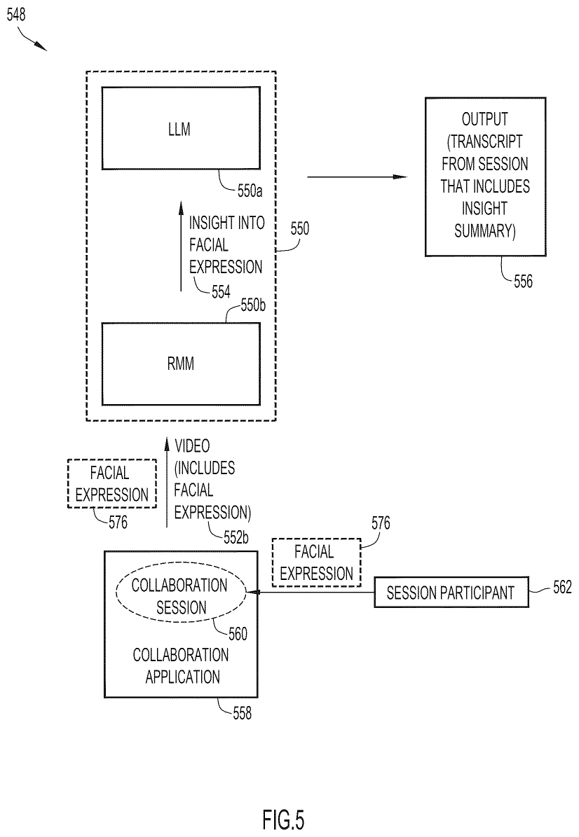

As mentioned above, a facial expression of a participant in a session hosted by a session service arrangement may be processed, and an insight associated with the facial expression may effectively be accounted for in a transcript created from the session. FIG. 5 is a diagrammatic representation of an intelligence system which processes content that includes a facial expression of a participant in a collaboration session in accordance with an embodiment. An intelligence system 548, which may be a framework or a platform, includes an AI system 550 that includes an LLM 550a and a RMM 550b. It should be appreciated that AI system 550 is effectively a combination or merger of LLM 550a and RMM 550b.

Intelligence system 548 also includes a collaboration application 558 which hosts a collaboration session 560, and a session participant 562 who participates in or is otherwise included in collaboration session 560. During collaboration session 560, session participant 562 makes a facial expression 576. Facial expression 576 may involve facial features including, but not limited to including, eyes, eyebrows, a mouth, and a nose. Facial expression 576 may include, but is not limited to including, a smile, a frown, a wink, wide open eyes, a wrinkled nose, one or more raised eyebrows, a look of surprise, a look of fear, a look of disgust, a change in expression etc. It should be appreciated that intelligence system 548 may be configured to accommodate differences in interpretations of facial expressions 576 in different countries and/or cultures. For example, a particular facial expression 576 may have different meanings in different cultures

Facial expression 576 may be captured, e.g., live-streamed and/or recorded, in a video 552b or video content by collaboration application 558 during collaboration session 560. Video 552b may be provided by collaboration application 558 to AI system 550. RMM 550b may process video 552b to identify the presence of facial expression 576 in video 552b, and to obtain at least one insight 554 into facial expression 576. RMM 550b may provide insight 554 to LLM 550a in a format suitable for processing by LLM 550a. LLM 550a may process insight 554 to generate an insight summary that relates to insight 554. AI system 550 may then generate an output 556 that includes a summary or other information, e.g., an interpretation or conclusion, relating to insight 554. Output 556 may generally be a transcript of conversations and/or presentations that occur during collaboration session 560. In the described embodiment, output 556 includes the summary of insight 554 such that the summary of insight 554 may be placed within output 556 at an appropriate chronological location, e.g., a location in output 556 that corresponds to a time at which facial expression 576 was made. It should be appreciated that the location at which summary of insight 554 may be placed within output 556 may vary widely, and is not limited to a chronological location.

When facial expression 576 is a smile, insight 554 may be that session participant 562 smiled after a particular statement was made during collaboration session 560. A summary of insight 554 included in output 556 may indicate that session participant 562 agreed with the particular statement. As such, when output 556 is a transcript or transcription record, the summary that indicates that session participant 562 agreed with the particular statement may appear at a location near the particular statement.

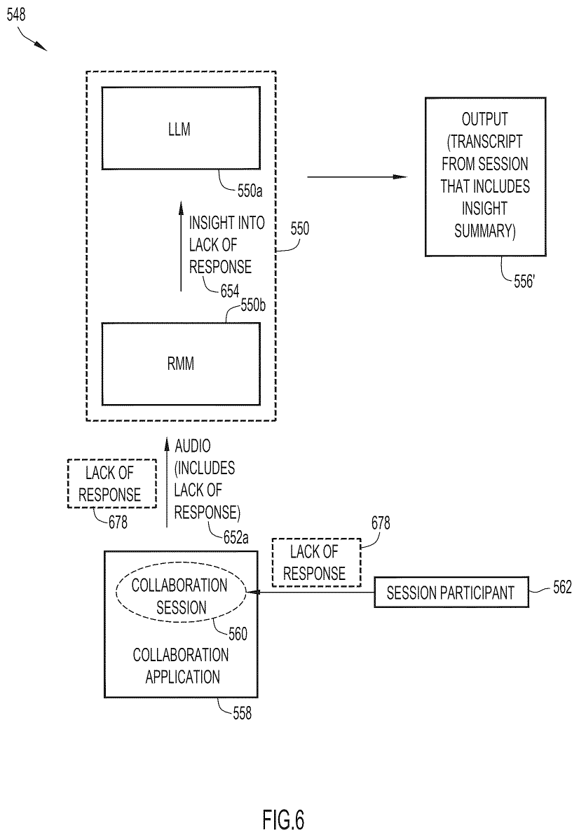

Intelligence system 548 may also determine an insight into a lack of response from session participant 562. Referring next to FIG. 6, the processing of content that includes a lack of a response from session participant 562 in collaboration session 560 will be described in accordance with an embodiment. Session participant 562 may provide or otherwise produce a lack of response 678 during collaboration session 560, as for example when session participant 562 is asked to provide an answer to a question. That is, session participant 562 may effectively fail to proffer a response when prompted by remaining silent. In one embodiment, lack of response 678 may be due to session participant 562 being temporarily away from collaboration session 560.

Collaboration application 558 may capture audio 652a or audio content during collaboration session 560, and lack of response 678 may be substantially evident in audio 652a. Audio 652a may be obtained by AI system 550. RMM 550b may process audio 652a to determine that audio 652a includes lack of response 678, and further process audio 652a to obtain at least one insight 654 into lack of response 678.

Insight 654 is provided to LLM 550a by RMM 550b. LLM 550a may process insight 654 to produce a summary related to insight 654. AI system 550 may generate output 556′, as for example a transcript or transcription record that includes the summary related to insight 654. The summary may indicate that session participant 562 did not respond to a particular overture, question, or comment, and may indicate a reason why session participant 562 did not respond, e.g., session participant may have temporarily stepped away or is otherwise temporarily unavailable from collaboration session 560. As mentioned above, session participant 562 may be deemed to have temporarily stepped away from collaboration session 560 if session participant 562 indicates a BRB status.

If session participant 562 is determined to be away from collaboration session 560, the summary included in output 556′ may include an explanation that session participant 562 was asked for input, but was away from collaboration session 560 and unable to provide input during collaboration session 560. Output 556′ may be a transcript that also includes an indication that session participant 562 may provide input after collaboration session 560, and may include a prompt for session participant 562 to enter his or her input directly into the transcript. In one embodiment, session participant 562 may be contacted, as for example by a texted or emailed message, to provide input. It should be appreciated that in lieu of session participant 562 entering input directly into the transcript, session participant 562 may instead verbally speak input into collaboration application 558, as for example during collaboration session 560, such that the input may be interpreted and added to the transcript.

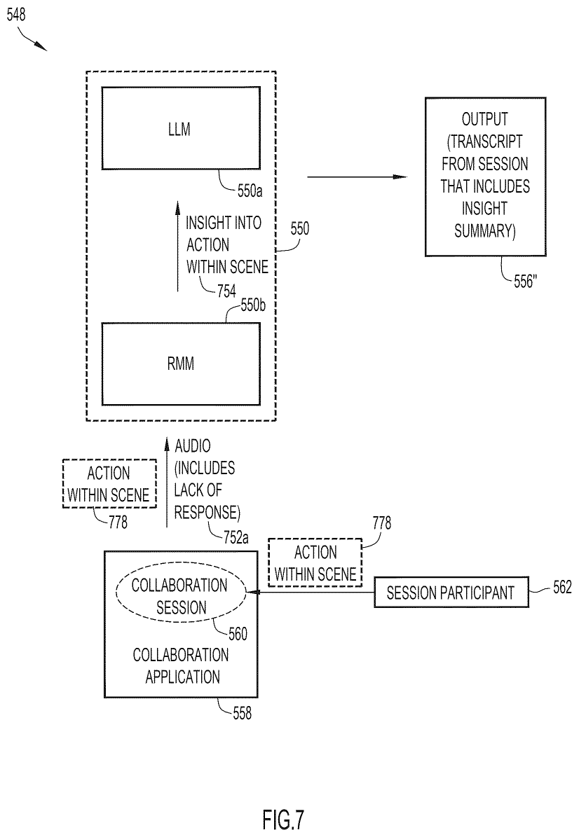

Intelligence system 548 may process content captured during collaboration session 560 that relates to an action or other occurrence within a scene associated with collaboration session 560. FIG. 7 is a diagrammatic representation of intelligence system 548 processing content that includes an action within a scene captured during collaboration session 560 in accordance with an embodiment. During collaboration session 560, session participant 562 may be associated with an action within a scene 778. Action within scene 778 may involve session participant 562, or may not directly involve session participant 562 but may be captured by a camera associated with session participant 562. By way of example, action within scene 778 may be an individual pointing to a physical whiteboard in a room that session participant 562 is present in, and making reference to a diagram drawn or otherwise depicted on the whiteboard. Action within scene 778 may also involve physical interactions between individuals, which may include session participant 562, such as one individual gesturing to another individual who is passing by to join collaboration session 560. In one embodiment, action within scene 778 may include indirect events such as nodding and head shaking to indicate agreement and disagreement, respectively.

Action within scene 778 may be captured by collaboration application 558 during collaboration session 560 in a video 752a or video contact, and included in video 752a provided to AI system 550. RMM 550b may process video 752a to identify action within scene 778 and, further, to determine at least one insight 754 into action within scene 778. When action within scene 778 is an individual pointing at a diagram drawn on a whiteboard, insight 754 may include identifying features of the diagram that the individual is referencing.

LLM 550a may process insight 754, and AI system 550 may cause output 556″ to be generated that includes a summary of insight 754. When insight 754 involves features of a diagram drawn on a whiteboard, LLM 550a may process any text in the diagram and include the text in the summary of insight 754.

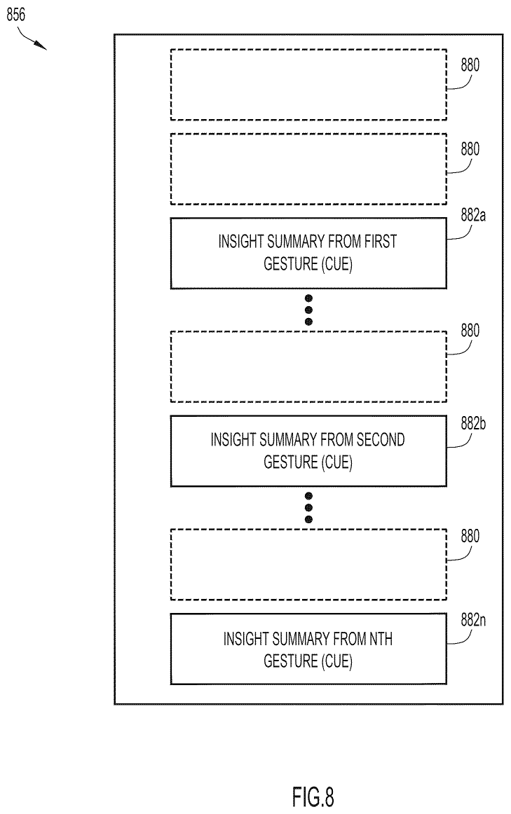

As previously mentioned, an output of an AI system such as AI system 550 of FIGS. 5-7 may be a transcript or a transcription report in which insight summaries, e.g., summaries of insights generated by RMM 550b and interpreted by LLM 550a, are included. FIG. 8 is a diagrammatic representation of a general transcript or transcription report that includes insight summaries in accordance with an embodiment. A transcript 856, which may include text representations 880 of speech captured during a collaboration session, includes insight summaries 882a-n that may be generated by an AI system that is part of an overall session transcription service. Insight summaries 882a-n may correspond to actions that are included in content obtained during a collaboration session, for which insights are generated by RMM and interpreted by an LLM.

Insight summary 882a may be associated with a first gesture or cue captured in a video of a collaboration session, insight summary 882b may be associated with a second gesture or cue captured in the video, and insight summary 882n may be associated with an nth gesture or cue captured in the video. The first gesture, second gesture, and nth gesture may be made by different participants in the collaboration session, or may be made by the same participant.

Insight summaries 882a-n may be positioned, situated, placed, or located in transcript 856 in positions that correspond to when gestures were made. By way of example, if the first gesture was made in response to a particular comment reflected in a particular text representation 880, insight summary 882a may be positioned in transcript at a location near the particular text representation 880.

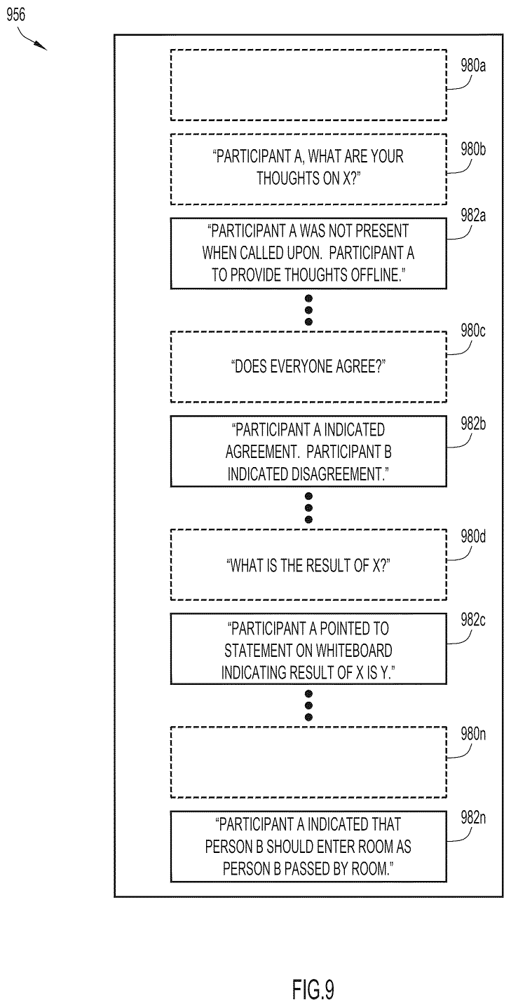

Referring next to FIG. 9, an example of a transcript that includes insight summaries in accordance with an embodiment. A transcript 956 associated with a collaboration session or meeting includes text representations 980a-n that correspond to speech captured or otherwise obtained during the collaboration session. Transcript 956 also includes insight summaries 982a-n. Insight summaries 982a-n may be associated with insights substantially extracted from audio, video, and/or shared content captured during a collaboration session.

As shown, text representation 980a may not have an insight summary associated therewith. Text representation 980b may be a question in which “Participant A” is asked for thoughts on topic “X.” Insight summary 982a which corresponds to text representation 980b may indicate that “Participant A” was not present when asked for thoughts, and may provide thoughts offline, or at a later time. Insight summary 982a may be based on an insight that “Participant A” was not seen in video content or heard in audio content at the time “Participant A.”

Text representation 980c may be a question that asks participants in the collaboration session whether all are in agreement. Insight summary 982b may summarize reactions, e.g., “Participant A” indicated agreement and “Participant B” indicated disagreement. The insights may be obtained from gestures, facial expressions, and or other cues from “Participant A” and “Participant B.” Rather than describing gestures, e.g., rather than stating that “Participant A” nodded and “Participant B” shook his or her head, insight summary 982b provides insight into the gestures.

Text representation 980d may be a question about a result. Insight summary 982c, which summarizes an insight based on an action taken by a participant in the collaboration session in response to the question set forth in text representation 980d, indicates that “Participant A” pointed to a statement on a whiteboard that answers the question about the result. Insight summary 982c may also include the statement that is the answer to the question. In one embodiment, rather than indicating that “Participant A” pointed to the statement, insight summary 982c may instead provide the answer to the question without noting that “Participant A” effectively pointed out the answer.

Insight summary 982n may be a summary of an insight associated with a gesture by “Participant A′” to “Person B” to enter a room, e.g., the room from which “Participant A” is participating in the collaboration session. The gesture by “Participant A” may be a wave or a beckoning gesture for which the insight is that “Person B” is to enter the room. The indication that “Person B” is invited to enter the room may be positioned in transcript 956 chronologically after text representation 980n, e.g., when “Person B” is invited to enter the room just after a statement summarized in text representation 980n was made.

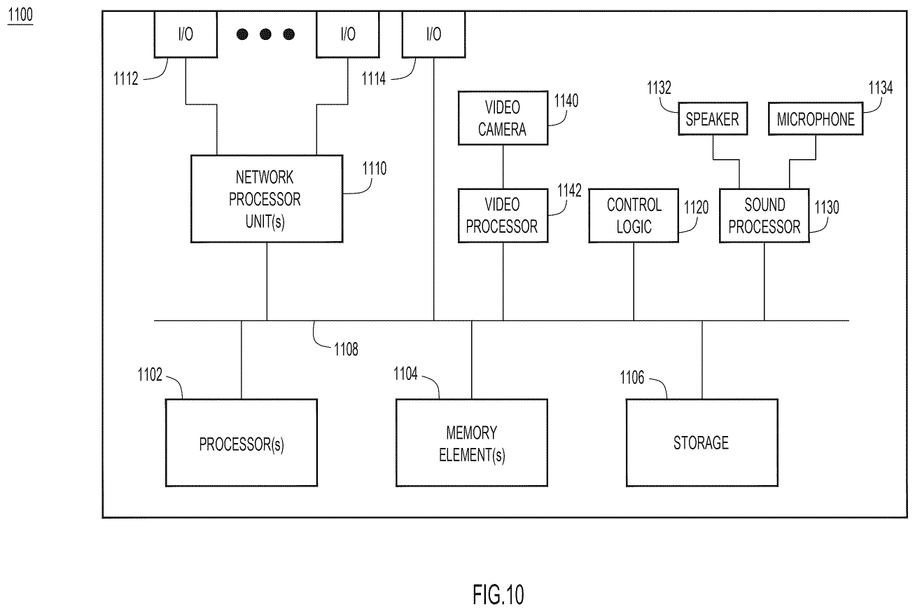

FIG. 10 is a hardware block diagram of a networking/computing device/apparatus/appliance/endpoint that may perform functions associated with any combination of operations in connection with the techniques described with respect to FIGS. 1A-C and 2-9. It should be appreciated that FIG. 6 provides only an illustration of one example embodiment and does not imply any limitations with regard to the environments in which different example embodiments may be implemented. Many modifications to the depicted environment may be made.

In at least one embodiment, the computing device 1100 may be any apparatus that may include one or more processor(s) 1102, one or more memory element(s) 1104, storage 1106, a bus 1108, one or more network processor unit(s) 1110 interconnected with one or more network input/output (I/O) interface(s) 1112, one or more I/O interface(s) 1114, and control logic 1120. In various embodiments, instructions associated with logic for computing device 1100 may overlap in any manner and are not limited to the specific allocation of instructions and/or operations described herein.

In at least one embodiment, processor(s) 1102 is/are at least one hardware processor configured to execute various tasks, operations and/or functions for device 1100 as described herein according to software and/or instructions configured for device 1100. Processor(s) 1102 (e.g., a hardware processor) may execute any type of instructions associated with data to achieve the operations detailed herein. In one example, processor(s) 1102 may transform an element or an article (e.g., data, information) from one state or thing to another state or thing. Any of potential processing elements, microprocessors, digital signal processor, baseband signal processor, modem, PHY, controllers, systems, managers, logic, and/or machines described herein may be construed as being encompassed within the broad term ‘processor’.

In at least one embodiment, one or more memory element(s) 1104 and/or storage 1106 is/are configured to store data, information, software, and/or instructions associated with device 1100, and/or logic configured for memory element(s) 1104 and/or storage 1106. For example, any logic described herein (e.g., control logic 1120) may, in various embodiments, be stored for device 1100 using any combination of memory element(s) 1104 and/or storage 1106. Note that in some embodiments, storage 1106 may be consolidated with one or more memory elements 1104 (or vice versa), or may overlap/exist in any other suitable manner. In one or more example embodiments, process data is also stored in the one or more memory elements 1104 for later evaluation and/or process optimization.

In at least one embodiment, bus 1108 may be configured as an interface that enables one or more elements of device 1100 to communicate in order to exchange information and/or data. Bus 1108 may be implemented with any architecture designed for passing control, data and/or information between processors, memory elements/storage, peripheral devices, and/or any other hardware and/or software components that may be configured for device 1100. In at least one embodiment, bus 1108 may be implemented as a fast kernel-hosted interconnect, potentially using shared memory between processes (e.g., logic), which may enable efficient communication paths between the processes.

In various embodiments, network processor unit(s) 1110 may enable communication between computing device 1100 and other systems, entities, etc., via network I/O interface(s) 1112 (wired and/or wireless) to facilitate operations discussed for various embodiments described herein. In various embodiments, network processor unit(s) 1110 may be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1100 and other systems, entities, etc. to facilitate operations for various embodiments described herein. In various embodiments, network I/O interface(s) 1112 may be configured as one or more Ethernet port(s), Fibre Channel ports, any other I/O port(s), and/or antenna(s)/antenna array(s) now known or hereafter developed. Thus, the network processor unit(s) 1110 and/or network I/O interface(s) 1112 may include suitable interfaces for receiving, transmitting, and/or otherwise communicating data and/or information in a network environment.

I/O interface(s) 1114 allow for input and output of data and/or information with other entities that may be connected to device 1100. For example, I/O interface(s) 1114 may provide a connection to external devices such as a keyboard, keypad, a touch screen, and/or any other suitable input device now known or hereafter developed. In some instances, external devices may also include portable computer readable (non-transitory) storage media such as database systems, thumb drives, portable optical or magnetic disks, and memory cards.

In various embodiments, control logic 1120 may include instructions that, when executed, cause processor(s) 1102 to perform operations, which may include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1120) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In the even the device 1100 is an endpoint (such as telephone, mobile phone, desk phone, conference endpoint, etc.), then the device 1100 may further include a sound processor 1130, a speaker 1132 that plays out audio and a microphone 1134 that detects audio. The sound processor 1130 may be a sound accelerator card or other similar audio processor that may be based on one or more ASICs and associated digital-to-analog and analog-to-digital circuitry to convert signals between the analog domain and digital domain. In some forms, the sound processor 1130 may include one or more digital signal processors (DSPs) and be configured to perform some or all of the operations of the techniques presented herein. The device 1100 may further include a video camera 1140 and a video processor 1142.

In some aspects, the techniques described herein relate to a method including: obtaining content captured during a collaboration session; processing the content to identify a first cue included in the content; interpreting the first cue, wherein interpreting the first cue includes generating a first insight associated with the first cue; processing the first insight to generate an insight summary; and generating an output associated with the collaboration session, wherein the output includes the insight summary.

In some aspects, the techniques described herein relate to a method wherein the content includes non-verbal content, and the first cue is a gesture performed by a participant in the collaboration session.

In some aspects, the techniques described herein relate to a method wherein the first insight includes an indication of a sentiment associated with the gesture.

In some aspects, the techniques described herein relate to a method wherein the output is a transcript associated with the collaboration session.

In some aspects, the techniques described herein relate to a method wherein obtaining the content captured during the collaboration session includes obtaining audio or video captured during the collaboration session.

In some aspects, the techniques described herein relate to a method wherein processing the content to identify the first cue includes extracting the first cue from the audio or video captured during the collaboration session.

In some aspects, the techniques described herein relate to a method wherein processing the content to identify the first cue included in the content includes processing the content using a RMM, and processing the first insight to generate the insight summary includes processing the first insight using an LLM.

In some aspects, the techniques described herein relate to an apparatus including: one or more network processor units to communicate with devices in a network; and a processor coupled to the one or more network processor units and configured to perform: obtaining content captured during a collaboration session, processing the content to identify a first cue included in the content, interpreting the first cue, wherein interpreting the first cue includes generating a first insight associated with the first cue, processing the first insight to generate an insight summary, and generating an output associated with the collaboration session, wherein the output includes the insight summary.

In some aspects, the techniques described herein relate to an apparatus wherein the content includes non-verbal content, and the first cue is a gesture performed by a participant in the collaboration session.

In some aspects, the techniques described herein relate to an apparatus wherein the first insight includes an indication of a sentiment associated with the gesture.

In some aspects, the techniques described herein relate to an apparatus wherein the output is a transcript associated with the collaboration session.

In some aspects, the techniques described herein relate to an apparatus wherein obtaining the content captured during the collaboration session includes obtaining audio or video captured during the collaboration session.

In some aspects, the techniques described herein relate to an apparatus wherein processing the content to identify the first cue includes extracting the first cue from the audio or video captured during the collaboration session.

In some aspects, the techniques described herein relate to an apparatus wherein processing the content to identify the first cue included in the content includes processing the content using a RMM, and processing the first insight to generate the insight summary includes processing the first insight using an LLM.

In some aspects, the techniques described herein relate to one or more non-transitory computer readable storage media encoded with instructions that, when executed by a processor, cause the processor to perform: obtaining content captured during a collaboration session; processing the content to identify a first cue included in the content; interpreting the first cue, wherein interpreting the first cue includes generating a first insight associated with the first cue; processing the first insight to generate an insight summary; and generating an output associated with the collaboration session, wherein the output includes the insight summary.

In some aspects, the techniques described herein relate to one or more non-transitory computer readable storage media wherein the content includes non-verbal content, and the first cue is a gesture performed by a participant in the collaboration session.

In some aspects, the techniques described herein relate to one or more non-transitory computer readable storage media wherein the first insight includes an indication of a sentiment associated with the gesture.

In some aspects, the techniques described herein relate to one or more non-transitory computer readable storage media wherein the output is a transcript associated with the collaboration session.

In some aspects, the techniques described herein relate to one or more non-transitory computer readable storage media wherein obtaining the content captured during the collaboration session includes obtaining audio or video captured during the collaboration session.

In some aspects, the techniques described herein relate to one or more non-transitory computer readable storage media wherein processing the content to identify the first cue included in the content includes processing the content using a RMM, and processing the first insight to generate the insight summary includes processing the first insight using an LLM.

Although only a few embodiments have been described in this disclosure, it should be understood that the disclosure may be embodied in many other specific forms without departing from the spirit or the scope of the present disclosure. By way of example, while an intelligence system that includes an AI system has generally been described as including a RMM and an LLM, the functionality of the RMM and the LLM may be substantially combined into a single model. Such a model may be hosted or distributed on one or more devices. Multiple LLMs and RMMs may also be implemented on a single system, and may communicate via a gateway.

An intelligence system may generally be configured to cater to particular countries and cultures, as mentioned above. As particular facial expressions and gestures may have different implications in different countries and/or cultures, an intelligence system may account of the differences. For example, a head shake in one culture may indicate agreement or a positive response, while a head shake in another culture may indicate disagreement or a negative response. An intelligence system may be configured to interpret a cue based upon a particular country and/or culture.

In one embodiment, the interpretation of insights may have different strengths associated therewith. For instance, while an agreement with a statement may be indicated by a gesture, a stronger agreement may be indicated by a combination of a gesture and a facial expression. By way of example, while a thumbs up may indicate an agreement with a statement, a thumbs up in addition to a smile may indicate a stronger agreement. A indication of whether an agreement is a strong agreement may be indicated in an insight summary.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which may be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 1106 and/or memory elements(s) 1104 may store data, software, code, instructions (e.g., processor instructions), logic, parameters, combinations thereof, and/or the like used for operations described herein. This includes the storage 1106 and/or memory elements(s) 1104 being able to store data, software, code, instructions (e.g., processor instructions), logic, parameters, combinations thereof, or the like that are executed to carry out operations in accordance with teachings of the present disclosure.

In summary, presented herein are a system and method to mix and act on AI generated outputs from LLMs and RMMs. Examples of other non-verbal cues may include gestures that a person may make with his/her hand, arm, etc., distinctive facial expressions, as well as audio aspects such as change in timbre, pitch and/or volume of a participant.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

As used herein, the terms “approximately,” “generally,” “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to convey that the property value may be within +/−5%, within +/−4%, within +/−3%, within +/−2%, within +/−1%, or even closer, of the given value.

Similarly, when a given feature is described as being “substantially parallel” to another feature, “generally perpendicular” to another feature, and so forth, this is intended to convey that the given feature is within +/−5%, within +/−4%, within +/−3%, within +/−2%, within +/−1%, or even closer, to having the described nature, such as being parallel to another feature, being perpendicular to another feature, and so forth. Mathematical terms, such as “parallel” and “perpendicular,” should not be rigidly interpreted in a strict mathematical sense, but should instead be interpreted as one of ordinary skill in the art would interpret such terms. For example, one of ordinary skill in the art would understand that two lines that are substantially parallel to each other are parallel to a substantial degree, but may have minor deviation from exactly parallel.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining content captured during a collaboration session;
processing the content to identify a first cue included in the content;
interpreting the first cue, wherein interpreting the first cue includes generating a first insight associated with the first cue;
processing the first insight to generate an insight summary; and
generating an output associated with the collaboration session, wherein the output includes the insight summary.

2. The method of claim 1 wherein the content includes non-verbal content, and the first cue is a gesture performed by a participant in the collaboration session.

3. The method of claim 2 wherein the first insight includes an indication of a sentiment associated with the gesture.

4. The method of claim 1 wherein the output is a transcript associated with the collaboration session.

5. The method of claim 1 wherein obtaining the content captured during the collaboration session includes obtaining audio or video captured during the collaboration session.

6. The method of claim 5 wherein processing the content to identify the first cue includes extracting the first cue from the audio or video captured during the collaboration session.

7. The method of claim 1 wherein processing the content to identify the first cue included in the content includes processing the content using a real-time media model (RMM), and processing the first insight to generate the insight summary includes processing the first insight using a large language model (LLM).

8. An apparatus comprising:
one or more network processor units to communicate with devices in a network; and
a processor coupled to the one or more network processor units and configured to perform:
obtaining content captured during a collaboration session,
processing the content to identify a first cue included in the content,
interpreting the first cue, wherein interpreting the first cue includes generating a first insight associated with the first cue,
processing the first insight to generate an insight summary, and
generating an output associated with the collaboration session, wherein the output includes the insight summary.

9. The apparatus of claim 8 wherein the content includes non-verbal content, and the first cue is a gesture performed by a participant in the collaboration session.

10. The apparatus of claim 9 wherein the first insight includes an indication of a sentiment associated with the gesture.

11. The apparatus of claim 8 wherein the output is a transcript associated with the collaboration session.

12. The apparatus of claim 8 wherein obtaining the content captured during the collaboration session includes obtaining audio or video captured during the collaboration session.

13. The apparatus of claim 12 wherein processing the content to identify the first cue includes extracting the first cue from the audio or video captured during the collaboration session.

14. The apparatus of claim 8 wherein processing the content to identify the first cue included in the content includes processing the content using a real-time media model (RMM), and processing the first insight to generate the insight summary includes processing the first insight using a large language model (LLM).

15. One or more non-transitory computer readable storage media encoded with instructions that, when executed by a processor, cause the processor to perform:
obtaining content captured during a collaboration session;
processing the content to identify a first cue included in the content;
interpreting the first cue, wherein interpreting the first cue includes generating a first insight associated with the first cue;
processing the first insight to generate an insight summary; and
generating an output associated with the collaboration session, wherein the output includes the insight summary.

16. The one or more non-transitory computer readable storage media of claim 15 wherein the content includes non-verbal content, and the first cue is a gesture performed by a participant in the collaboration session.

17. The one or more non-transitory computer readable storage media of claim 16 wherein the first insight includes an indication of a sentiment associated with the gesture.

18. The one or more non-transitory computer readable storage media of claim 15 wherein the output is a transcript associated with the collaboration session.

19. The one or more non-transitory computer readable storage media of claim 15 wherein obtaining the content captured during the collaboration session includes obtaining audio or video captured during the collaboration session.

20. The one or more non-transitory computer readable storage media of claim 15 wherein processing the content to identify the first cue included in the content includes processing the content using a real-time media model (RMM), and processing the first insight to generate the insight summary includes processing the first insight using a large language model (LLM).
